(19) United States
(12) Patent Application Publication
(10) Pub. No.: US 2025/0378764 A1
(43) Pub. Date: Dec. 11, 2025

(54) METHOD AND SYSTEM OF EXTENDIBLE ADAPTIVE TESTING BASED ON CONTINUOUS PROBABILISTIC ASSESSMENT

(71) Applicant: EXAMROOM.AI CORP., LAKE MARY, FL (US)

(72) Inventors: VINOD KUMAR JAYAKEERTHI, Sorrento, FL (US); PHILIP DUWAYNE DICKISON, Clearwater Beach, FL (US); HENRY LUND SORENSEN, Sandy, UT (US); DEEPAK MADHUKAR KOLEKAR, Bengaluru (IN)

(21) Appl. No.: 19/036,181

(22) Filed: Jan. 24, 2025

Related U.S. Application Data
(60) Provisional application No. 63/658,040, filed on Jun. 10, 2024.

(51) Int. Cl. G09B 7/00; G06Q 50/20

(52) U.S. Cl. CPC G09B 7/00; G06Q 50/205

(57) ABSTRACT

A method and system of adaptive testing via continuous probabilistic assessment. The method comprises continuously estimating a candidate performance measure (“THETA”) based on scoring a sequence of test performance submissions acquired from a candidate computing device in response to a sequence of items presented to the candidate computing device, determining, responsive to the continuously assessing, a probabilistic performance band that is associated with the THETA, generating, based at least in part on the probabilistic performance band and a predetermined cutoff score, a decision to extend the testing in accordance with an extended sequence of items presented to the candidate computing device, and assigning, based on the extended testing, a conclusive fail status or a conclusive pass status based on cumulatively updating the probabilistic performance band.

### RELATED APPLICATIONS

This application claims the benefit of priority to U.S. Provisional Patent Application No. 63/658,040 filed on Jun. 10, 2024. Said U.S. Provisional Patent Application No. 63/658,040 is hereby incorporated in its entirety.

### TECHNICAL FIELD

Disclosures herein relate to distributed computer network systems for adaptive examination testing.

### BACKGROUND

The introduction and increasing prevalence of online examinations has necessitated a requirement for secure, reliable and efficient technologies that facilitate a seamless testing experience while maintaining integrity of examination ecosystems. By standardizing test evaluation criteria and test administering processes, test candidates as well as test certifying entities and institutions can be assured of consistent and fair grading and evaluations, eliminating or at least minimizing biases that may arise in manually-oriented test delivery and candidate evaluation systems. Furthermore, standardizing test evaluation criteria and test administering processes better inform instructional strategies and help identify trends or gaps in learning.

### DESCRIPTION OF THE DRAWINGS

Whereas novel aspects believed characteristic of the invention are set forth in the appended claims, embodiments described herein will be understood by those of skill in the art with reference to the following detailed description and accompanying drawing figures in which like reference numerals indicate similar or identical features and components.

FIG. 1 shows, in an example embodiment, a distributed computer network system for extendible adaptive testing via continuous probabilistic assessment.

FIG. 2 shows, in an example embodiment, an architecture of a test delivery server computing system for extendible adaptive testing via continuous probabilistic assessment.

FIG. 3 shows, in an example embodiment, a first candidate assessment scenario in implementing extendible adaptive testing via continuous probabilistic assessment.

FIG. 4 shows, in another example embodiment, a second assessment scenario in implementing extendible adaptive testing via continuous probabilistic assessment.

FIG. 5 shows, in a further example embodiment, a third candidate assessment scenario for implementing extendible adaptive testing via continuous probabilistic assessment.

FIG. 6 shows, in another example embodiment, a fourth candidate assessment scenario in implementing extendible adaptive testing via continuous probabilistic assessment.

FIG. 7 shows, in a further example embodiment, a fifth candidate assessment scenario in implementing extendible adaptive testing via continuous probabilistic assessment.

FIG. 8 shows, in another example embodiment, a sixth assessment scenario for implementing extendible adaptive testing via continuous probabilistic assessment.

FIG. 9 shows, in an example embodiment, a process for deploying extendible adaptive testing via continuous probabilistic assessment.

### DETAILED DESCRIPTION

Embodiments herein recognize challenges in creating and administering standardized examinations or tests crafted for administering across a global population of candidates, while maintaining fairness, consistency and integrity of the examination process. In particular, techniques, processes, systems and features disclosed herein enhance the accuracy of probabilistic assessments in real time as the candidate continuously estimated and updated in real time as a test candidate progresses through sequences of items in accordance with mandated topics that a given test must assess. Embodiments herein disclose extendible testing methods based on probabilistic assessments designed to be scalable, flexible and also adaptable and compatible with various educational levels, diverse test subject areas and different educational institutions.

As referred to herein, an ‘item’ refers to a question or task presented for performance by a candidate in order to assess the candidate's skills, knowledge or proficiency in a particular subject. Such items may be sourced from an ‘item pool’, or ‘item bank’ as variously referred to herein, comprising a population or collection of all questions approved or otherwise designated for testing on a given examination or topic. Each question in the item pool may be pre-designated in accordance with specific classifications and details including, but not limited to, a level of difficulty, for deployment in the CAT contexts, including linear on the fly (LOFT) examinations

Provided is a method of rendering a test having a plurality of test questions (“items”) sourced from an item bank. The method comprises continuously estimating a candidate performance ability level (“THETA”) based at least in part upon scoring a sequence of test performance answers (“answers”) acquired from a candidate computing device in response to a sequence of items presented to the candidate computing device, determining, responsive to the continuously assessing, a probabilistic performance band that is associated with the THETA, generating, based at least in part on the probabilistic performance band and a predetermined cutoff score, a decision to extend the testing in accordance with an extended sequence of items presented to the candidate computing device, and assigning, in accordance with the extended testing, one of a conclusive fail status and a conclusive pass status based on cumulatively updating the probabilistic performance band in relation to the predetermined cutoff score.

Further provided is a test delivery server computing system communicatively coupled within a distributed network computing system. The test delivery server includes one or more processors and a memory storing instructions executable in the one or more processors. The instructions, when executed, cause the processor(s) to implement operations including continuously estimating a candidate performance ability level (“THETA”) based at least in part upon scoring a sequence of test performance answers (“answers”) acquired from a candidate computing device in response to a sequence of items presented to the candidate computing device, determining, responsive to the continuously assessing, a probabilistic performance band that is associated with the THETA, generating, based at least in part on the probabilistic performance band and a predetermined cutoff score, a decision to extend the testing in accordance with an extended sequence of items presented to the candidate computing device, and assigning, in accordance with the extended testing, one of a conclusive fail status and a conclusive pass status based on cumulatively updating the probabilistic performance band in relation to the predetermined cutoff score.

Also provided is a computer-readable non-transitory memory having instructions stored thereon. The instructions are executable to cause one or more processors to implement operations including continuously estimating a candidate performance ability level (“THETA”) based at least in part upon scoring a sequence of test performance answers (“answers”) acquired from a candidate computing device in response to a sequence of items presented to the candidate computing device, determining, responsive to the continuously assessing, a probabilistic performance band that is associated with the THETA, generating, based at least in part on the probabilistic performance band and a predetermined cutoff score, a decision to extend the testing in accordance with an extended sequence of items presented to the candidate computing device, and assigning, in accordance with the extended testing, one of a conclusive fail status and a conclusive pass status based on cumulatively updating the probabilistic performance band in relation to the predetermined cutoff score.

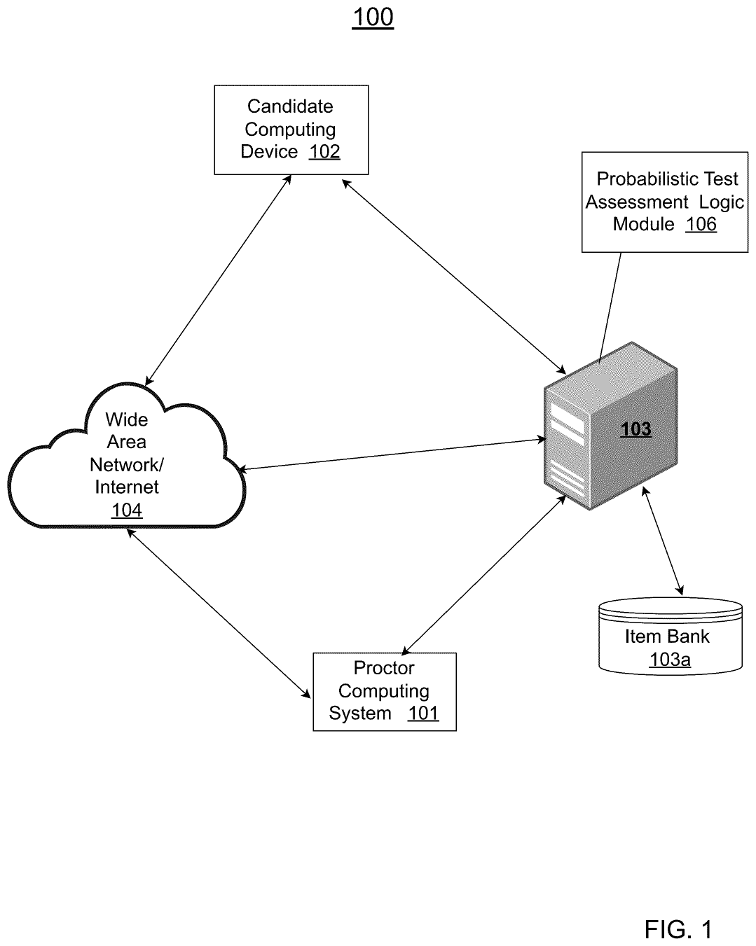

FIG. 1 shows, in an example embodiment, distributed computer network system 100 for extendible adaptive testing via continuous probabilistic assessment. In embodiments, network system 100 includes probabilistic test assessment logic module 106 of test delivery server computing system 103. Probabilistic test assessment logic module 106 may be constituted of processor-executable instructions stored in a memory of test delivery server computing system 103, or in some embodiments, proctor computing system 101, The instructions may then be instantiated via execution of the processor-executable instructions as stored. Test delivery server computing system 103 may be interconnected with proctor computing system 101, candidate computing device 102 for a candidate taking an examination, and database item bank 103a. In some embodiments, test delivery server computing system 103 may incorporate database item bank 103a. It is contemplated that the executable instructions may be stored in portions or components across test delivery server computing system 103 in conjunction with proctor computing system 101, implemented in parts or in whole across one or both of test delivery server computing system 103 in conjunction with proctor computing system 101 in combination, in some variations. Test delivery server computing system 103 and proctor computing system 101 may be interconnected directly, or via a local area network or wide area network 104, in some embodiments. In this manner, network system 100 for extendible adaptive testing may be deployed using processor devices and memory in any one of test delivery server computing system 103 and proctor computing system 101 or, in some embodiments, across both test delivery server computing system 103 and proctor computing system 101 working cooperatively, as will be apparent to those of skill in the art of distributed computer networking systems and cloud computing systems.

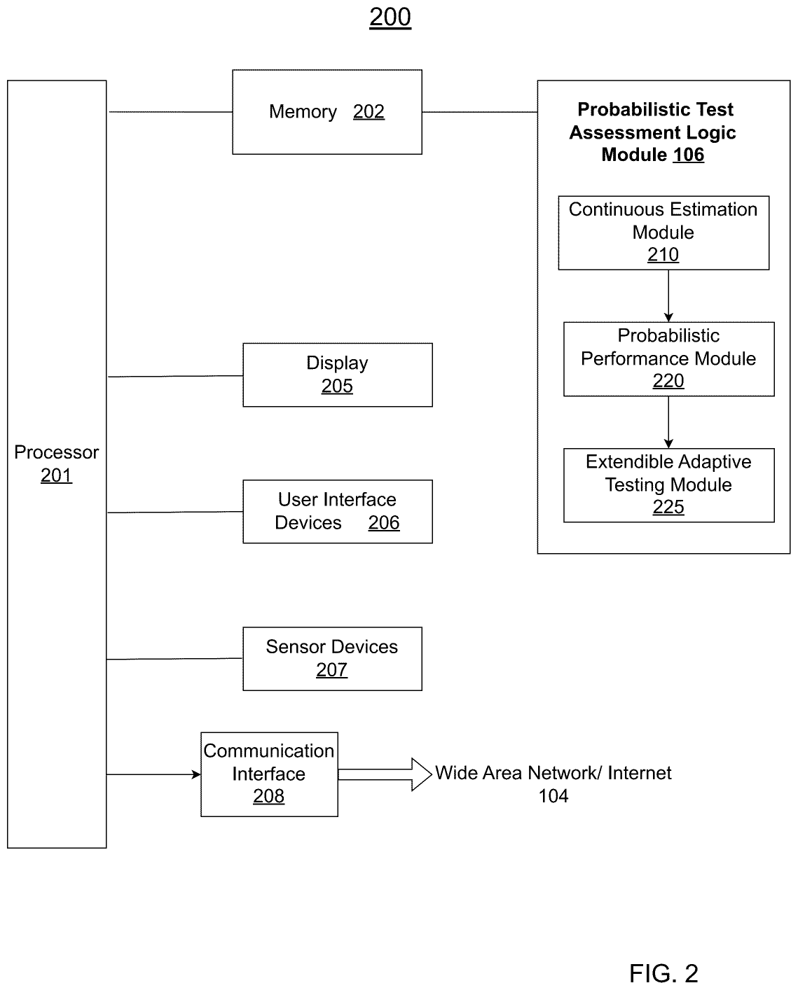

FIG. 2 shows, in an example embodiment, architecture 200 of a test delivery server computer system 103 within distributed computer network system 100 for of a test delivery server computing system for extendible adaptive testing via continuous probabilistic assessment. The example embodiment of architecture 200 will be described with reference to test delivery server computing system 103 rendering a test having a plurality of test questions (‘items’) sourced from item bank 103a that includes a plurality of unique test items. However, it is contemplated that, as will be appreciated by ones of skill in the art of distributed computing networks, at least some portions of logic componentry and functionality ascribed to test delivery server computing system 103 may be incorporated into proctor computing system 101, or similar interconnected computing systems, in alternate or additional embodiments. For instance, it is contemplated that at least some of the functionality of probabilistic test assessment logic module 106, including continuous estimating module 210 and probabilistic performance module 220 may be implemented or incorporated variously, including in portions or an entirety, across test delivery server computing system 103 in conjunction with proctor computing system 101, communicatively coupled by way of communication interface 208 via wide area network 104.

In embodiments, test delivery server computer system 103 may include memory 202, processor 201, display 205, user interface devices 206, sensor devices 206 such as a camera or imaging sensor, and communication interface 208 that provides interconnectivity with wide area network 104.

Probabilistic test assessment logic module 106, constituted of continuous estimating module 210, probabilistic performance module 220 and extendible adaptive testing module 225, may be implemented using programmable instructions stored in memory 202 that are executable in one or more processor devices, including such as processor 201. Memory 202 may include, though not necessarily be limited to, non-volatile memory device(s), including dynamic random access memory (DRAM) or static random access memory (SRAM) non-transitory memory storage media or devices, and any combinations thereof. Although functionality ascribed to probabilistic test assessment logic module 106 is described herein, for sake of providing clarity to ones of ordinary skill in the art, in context of discrete logic modules, continuous estimating module 210, candidate performance module 220 and candidate status module 225, it is expected that functionality ascribed to probabilistic test assessment logic module 106 herein should not be limited in implementation to such literal configuration of discrete logic modules used to describe example embodiments herein. For instance, in alternate or additional embodiments, at least some functional aspects of those discrete modules may be incorporated or subsumed, at least in portions, variously across others of those discrete logic modules.

In some variations, at least some portions of functionality of probabilistic test assessment logic module 106 including its constituent logic modules, specifically continuous estimating module 210, probabilistic performance module 220 and extendible adaptive testing module 225 may be implemented in accordance with hard-wired circuitry and electronic componentry. The hard-wired circuitry and electronic componentry may be, without limitation, such as field programmable gate array (FPGA) devices, application specific integrated circuit (ASIC) devices and similar hard-wired electronic circuitry and componentry device implementations.

Continuous estimating module 210 includes logic instructions for implementing functionality that includes logic instructions for implementing functionality related to continuously estimating a candidate performance ability level (“THETA”) based at least in part upon scoring a sequence of test performance answers (“answers”) acquired from a candidate computing device in response to a sequence of items presented to the candidate computing device. In embodiments, THETA may be established once a candidate has completed and submitted answers in response to a predetermined, initial set of questions. Then that initial THETA is continuously calculated and updated with each subsequent answer completed, submitted and scored (a “raw score”) by the candidate at candidate computing device 102.

In embodiments, the scoring is based on raw scores associated with the candidate's sequence of answers, and continuously estimating the THETA is based at least in part on the scoring and an observed candidate performance pattern pertaining to the sequence of answers. The candidate performance pattern may be based at least in part on a probability of the candidate correctly answering a next item and a probability of a candidate guessing in answering the next item, given the candidate cumulative history of answering on at least the predetermined, initial set of questions. In some aspects, the probability of a given candidate correctly answering the next item and also the probability of candidate guessing in answering the next item may be based at least in part upon a predetermined difficulty level associated with each next item to be presented to the candidate.

Probabilistic performance module 220, in embodiments, includes logic instructions for determining, responsive to continuously estimating THETA, a probabilistic performance band that is associated with the THETA as estimated, a new estimation of THETA being established with each additional candidate answer that is completed, submitted and scored. In some embodiments, the probabilistic performance band comprises a range of THETA values determined in accordance with a predetermined statistical confidential interval (CI) associated with respective ones of the THETA in accordance with the continuously estimating of THETA. In some aspects, standard probability techniques for calculating the statistical confidence interval for each value of THETA determined may be applied. In some specific embodiments, the predetermined statistical CI may be a 90% +/−5% range.

Extendible adaptive testing module 225, in embodiments, includes logic instructions for generating, based at least in part on the probabilistic performance band and a predetermined cutoff score, a decision to extend the testing based on presenting an extended sequence of items to the candidate computing device. During the extended test, as each of the extended sequence of items are answered and scored, the probabilistic performance band can be continuously updated.

In some embodiments, a conclusive fail status is assigned to the candidate subject to the candidate performance band converging around a trendline associated with the THETA being below the cutoff score during at least a portion of the extended testing. A conclusive pass status can be assigned the conclusive pass status is assigned subject to the candidate's performance band converging around a trendline associated with the THETA, when the trendline is established as being above the cutoff score during at least a portion of the extended testing. In related variations, the conclusive pass status is assigned subject to the THETA being above the cutoff score during at least a portion of the extended testing, without regard to the confidence band trendline that is based on the CI.

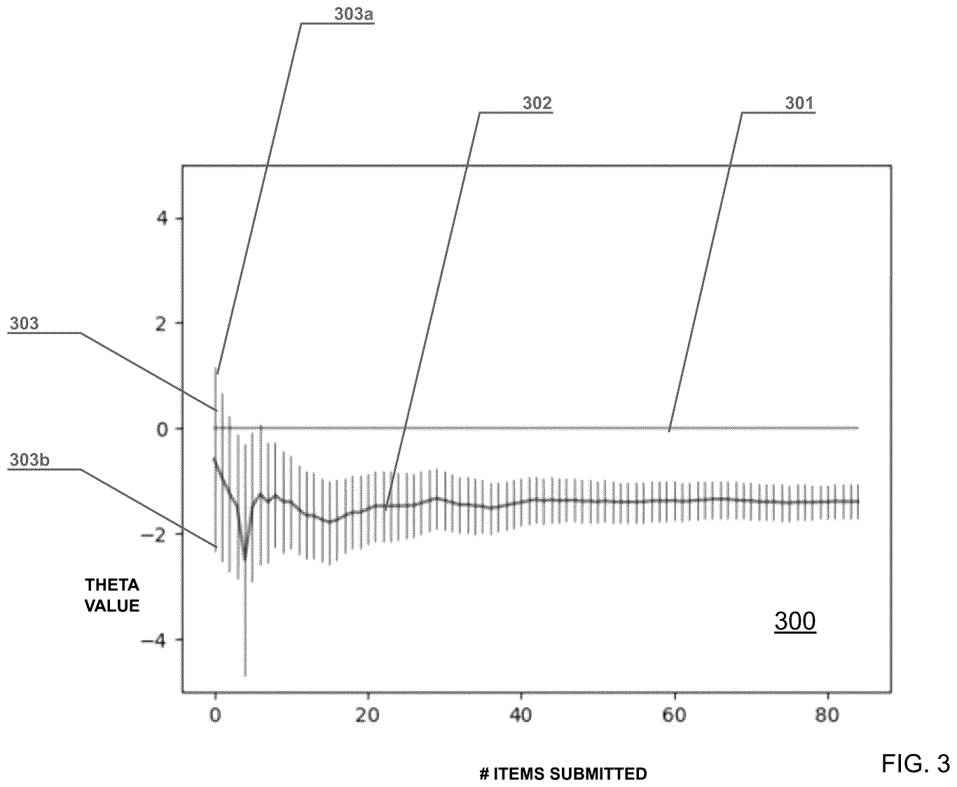

FIG. 3 shows, in an example embodiment, a first candidate assessment scenario 300 in implementing extendible adaptive testing via continuous probabilistic assessment. In embodiments, scheme 300 may be implemented by applying any of the devices, systems, and features as described in FIGS. 1-9 for use in conjunction with scenario 300. Cutoff score 301, in some embodiments being based on a predetermined THETA value, may be set as a desired standard for the exam candidates. Actual THETA value 302 may be calculated and updated based on each additional answer received from a candidate in response to each additional question or item that is presented to the candidate during the examination. Performance band 303 may be calculated, centered around THETA value 302. The performance band, ranging from extremities 303a to 303b for the particular THETA value, in embodiments, may be established based on a statistical confidence interval CI that is calculated and associated with each respective THETA value. CI may be based, in an example embodiment, on a 90% confidence level +/−5%. In candidate assessment 300 as depicted, the top end of the performance band 300 is well below the cutoff score based on a zero value for THETA, and the candidate can be assigned a conclusive fail status.

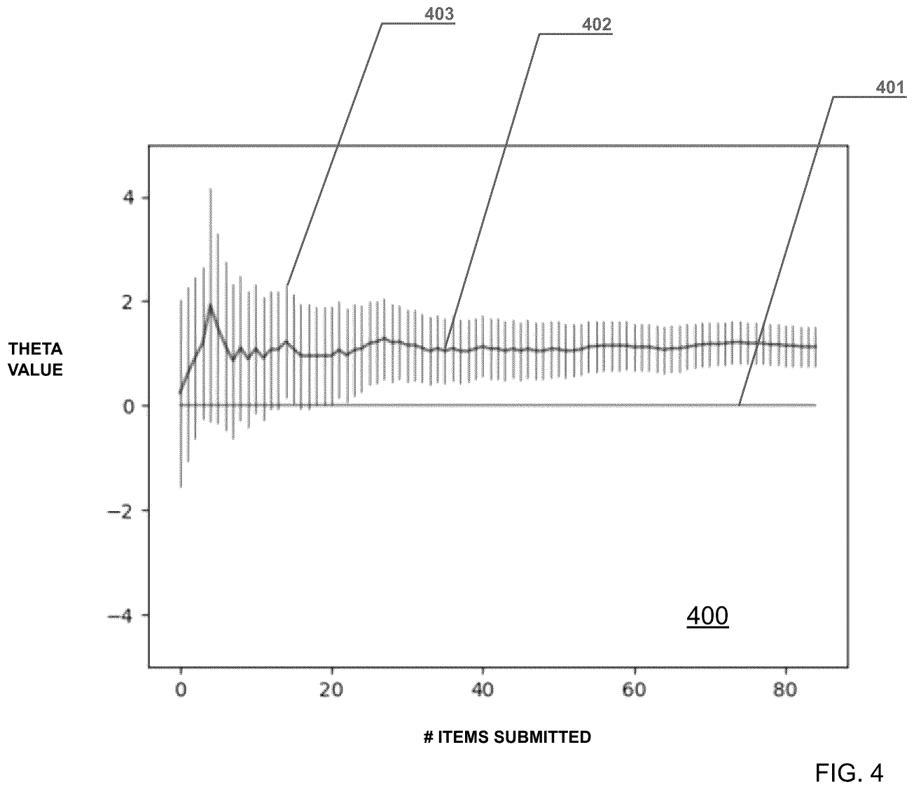

FIG. 4 shows, in another example embodiment, a second assessment scenario 400 in implementing extendible adaptive testing via continuous probabilistic assessment. Based on cutoff score 410 with theta value of zero, having theta trendline 402 and associated performance band 403, the lower limit of performance band 403 is well above cutoff score 401 with 95% certainty (corresponding to a 90% +/−5% CI), and the examination candidate can be assigned a conclusive pass status.

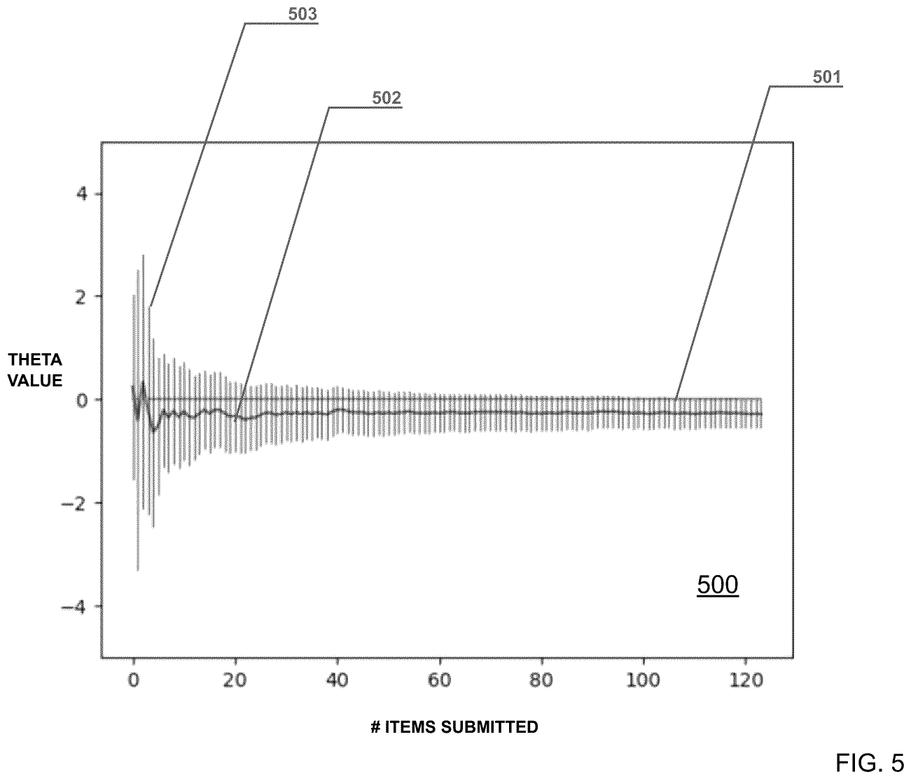

FIG. 5 shows, in a further example embodiment, a third candidate performance assessment scenario 500 for implementing extendible adaptive testing via continuous probabilistic assessment. In this embodiment of a variable length additional section of the test, a decision has already been made to extend the test, via additional sequence of questions presented to the candidate for answering.

The situation depicted in FIG. 5 transpires when, at the end of a predetermined minimum length section of the test, confidence interval range 503 based on THETA 502 that is estimated candidate ability is neither clearly above nor below cutoff score 501. Additional questions, representative of the extended test, are presented to the candidate until the upper or lower limit of the confidence interval-based confidence band 503 becomes established as above or below the cutoff score 500. In this particular case depicted, after 124 items, the upper limit of the 95% confidence limit is clearly above the cutoff score, confidently marking the test-taker as ‘NOT PASS’ or a conclusive fail with 95% certainty.

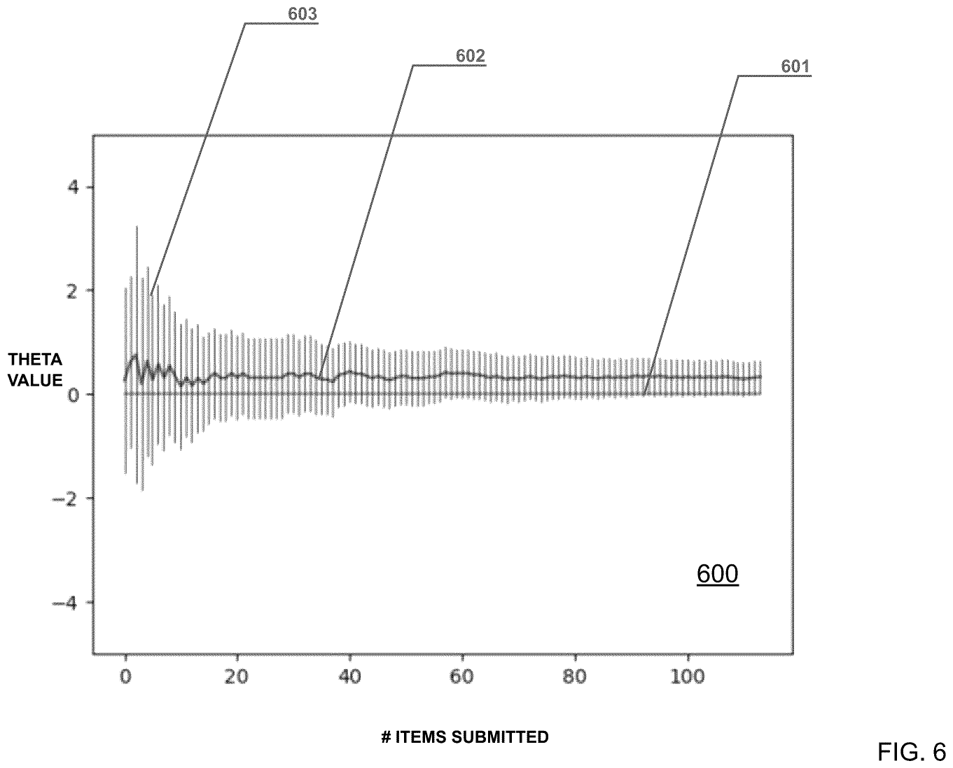

FIG. 6 shows, in another example embodiment, a fourth candidate performance assessment scenario 600 in implementing extendible adaptive testing via continuous probabilistic assessment. In this embodiment, the test-taker answers extended testing questions and their estimated ability confidence interval-based range 603 in accordance with estimated ability 602, is established as above the cutoff score 601. The embodiment as depicted transpires when, at the minimum length section's end, the confidence interval range for candidate's estimated ability is not decisively above or below the cutoff score 501. More questions are given in extended testing until either the upper or lower confidence limit crosses cutoff score 601. In this scenario, after the exam length of 114 items, the lower confidence limit of the 95% band is established as definitively above the cutoff score, confidently marking the test-taker as a conclusive ‘PASS’ with 95% certainty.

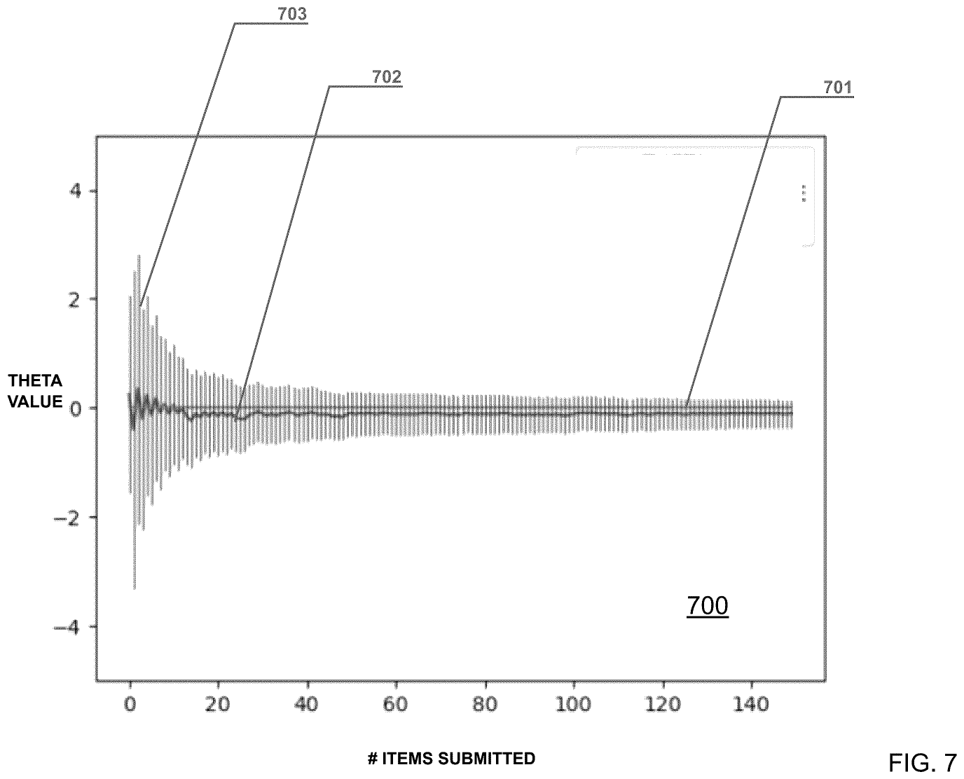

FIG. 7 shows, in a further example embodiment, a fifth candidate assessment performance scenario 700 in implementing extendible adaptive testing via continuous probabilistic assessment. If the test taking candidate responds or completes the maximum number of items in the variable section, but the extrema of the confidence interval range 703 does not clearly cross cutoff score 701, their estimated ability is below cutoff score 701. In such case, the candidate is assessed solely based on their final estimated ability without considering the 95% confidence intervals. Since their final ability as measured by THETA 702 is below the cutoff score, they are classified as ‘NOT PASS’ or conclusive fail.

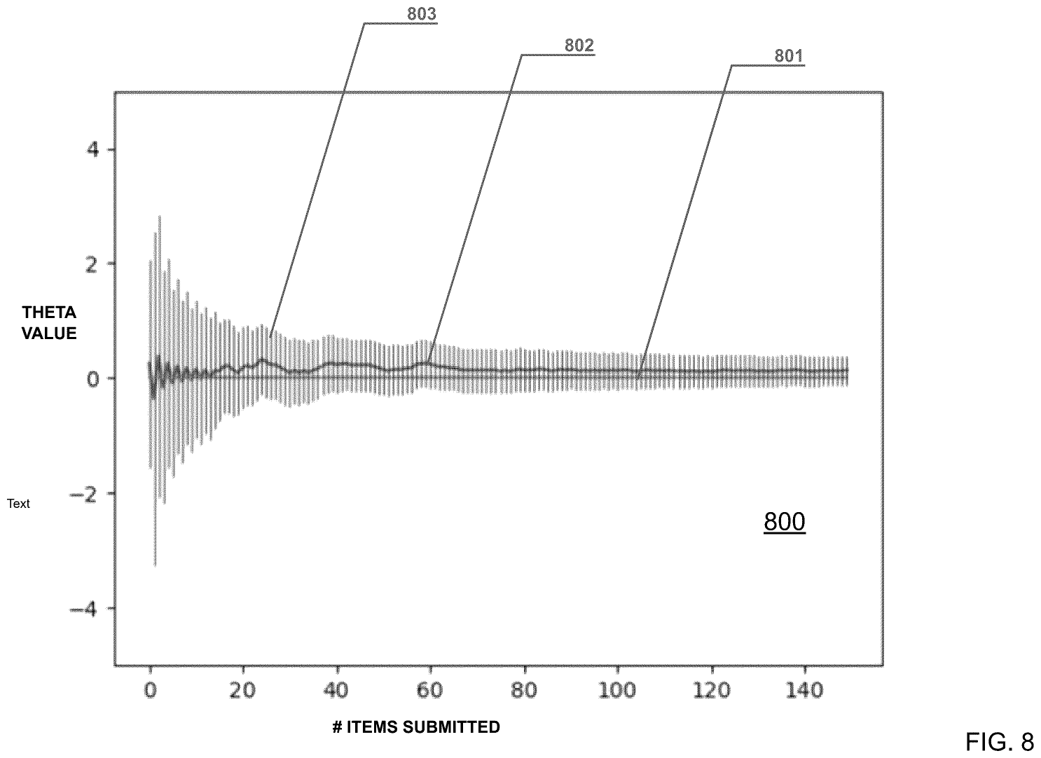

FIG. 8 shows, in another example embodiment, a sixth candidate assessment performance scenario 800 for implementing extendible adaptive testing via continuous probabilistic assessment. If the test-taker responds or answers the maximum variable section questions, and the confidence interval- based performance band 803 does not decisively cross cutoff score 801, but their estimated ability THETA 802 is established as above it, they are assigned a conclusive pass. In such case, the test candidate is assessed solely on their final estimated ability THETA 802, disregarding the 95% confidence intervals, and since their final ability is above the cutoff score, they are classified as as a conclusive ‘PASS’.

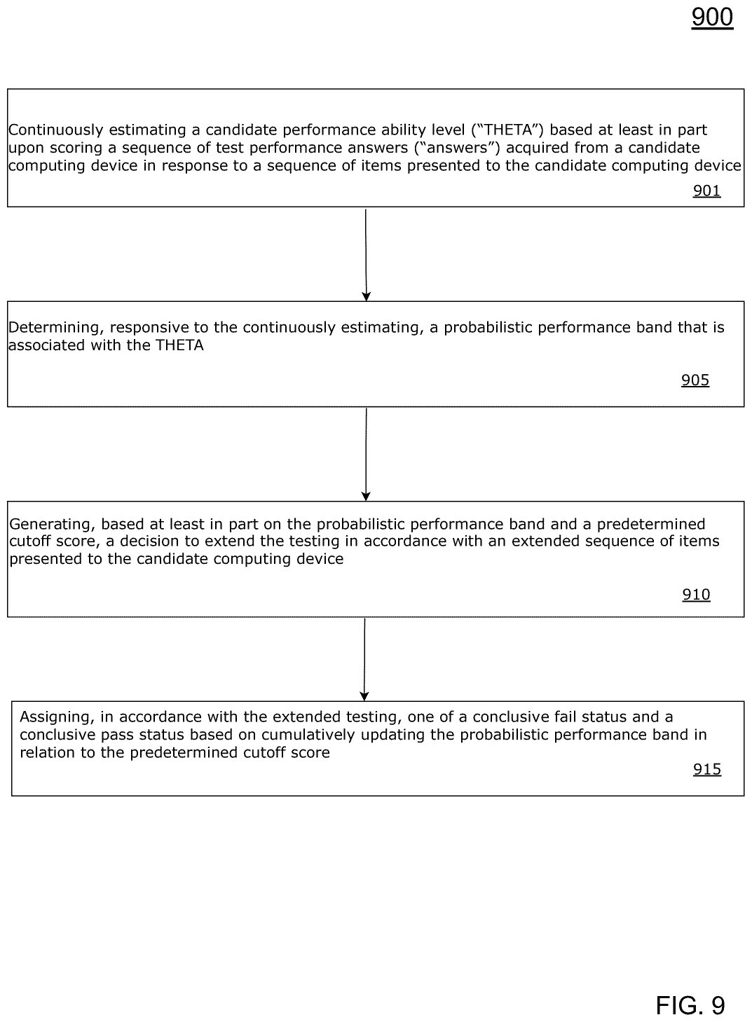

FIG. 9 shows, in an example embodiment, process 900 in deploying extendible adaptive testing via continuous probabilistic assessment. In embodiments, process 900 may be implemented by applying any of the devices, systems, techniques and features as described in FIGS. 1-8. In embodiments, process 400 may be implemented via computer processor executable instructions stored on memory storage media devices. In other embodiments, at least some of the computer processor executable instructions stored on memory storage media devices may be implemented, wholly or at least partially, in electronically hardwired devices, including, without limitation, field programmable gate array (FPGA) semiconductor devices or application specific integrated circuit (ASIC) semiconductor devices.

At step 901, continuously estimating a candidate performance ability level (“THETA”) based at least in part upon scoring a sequence of test performance answers (“answers”) acquired from a candidate computing device 102 in response to a sequence of items presented to the candidate computing device.

At step 905, determining, responsive to the continuously estimating, a probabilistic performance band that is associated with the THETA.

At step 910, generating, based at least in part on the probabilistic performance band and a predetermined cutoff score, a decision to extend the testing in accordance with an extended sequence of items presented to the candidate computing device.

At step 915, assigning, in accordance with the extended testing, one of a conclusive fail status and a conclusive pass status based on cumulatively updating the probabilistic performance band in relation to the predetermined cutoff score.

In embodiments, the scoring is based on raw scores associated with the candidate's sequence of answers, and continuously estimating the THETA is based at least in part on the scoring and an observed candidate performance pattern pertaining to the sequence of answers. The candidate performance pattern may be based at least in part on a probability of the candidate correctly answering a next item and a probability of a candidate guessing in answering the next item, given the candidate cumulative history of answering on at least the predetermined, initial set of questions. In some aspects, the probability of a given candidate correctly answering the next item and also the probability of candidate guessing in answering the next item may be based at least in part upon a predetermined difficulty level associated with each next item to be presented to the candidate.

In some embodiments, the probabilistic performance band comprises a range of THETA values determined in accordance with a predetermined statistical confidential interval (CI) associated with respective ones of the THETA in accordance with the continuously estimating of THETA. In some aspects, standard probability techniques for calculating the statistical confidence interval for each value of THETA determined may be applied. In some specific embodiments, the predetermined statistical CI may be a 90% +/−5% range.

In embodiments, during the extended test, as each of the extended sequence of items are answered and scored, the probabilistic performance band can be continuously updated. A conclusive fail status may be assigned to the candidate subject to the candidate performance band converging around a trendline associated with the THETA being below the cutoff score during at least a portion of the extended testing. A conclusive pass status can be assigned the conclusive pass status is assigned subject to the candidate's performance band converging around a trendline associated with the THETA, when the trendline is established as being above the cutoff score during at least a portion of the extended testing. In related variations, the conclusive pass status is assigned subject to the THETA being above the cutoff score during at least a portion of the extended testing, without regard to the confidence band trendline that is based on the CI.

It is contemplated that embodiments described herein be understood to include and encompass varying combinations of elements and concepts recited anywhere in this application. Although embodiments are described in detail herein with reference to the accompanying drawings, it is to be understood that the invention is not limited to only such literal embodiments. For example, it is anticipated that the techniques and systems may be applied or deployed to cases other than any particular test configurations including but not necessarily limited to, linear and linear on the fly (LOFT) test contexts. Furthermore, it is contemplated that a particular feature described either individually or as part of an embodiment can be combined with other features as described, or parts of other embodiments, even in the absence of a particular described combination. Thus, absence of particular described combinations does not preclude the inventor from claiming rights to such combinations. As such, many modifications and variations will be apparent to practitioners skilled in the art. Accordingly, it is intended that the scope of the invention be defined by the following claims and their equivalents.

What is claimed is:

1. A method of rendering a test having a plurality of test questions (“items”) sourced from an item bank, the method comprising:
continuously estimating a candidate performance ability level (“THETA”) based at least in part upon scoring a sequence of test performance answers (“answers”) acquired from a candidate computing device in response to a sequence of items presented to the candidate computing device;
determining, responsive to the continuously estimating, a probabilistic performance band that is associated with the THETA;
generating, based at least in part on the probabilistic performance band and a predetermined cutoff score, a decision to extend the testing in accordance with an extended sequence of items presented to the candidate computing device; and
assigning, in accordance with the extended testing, one of a conclusive fail status and a conclusive pass status based on cumulatively updating the probabilistic performance band in relation to the predetermined cutoff score.

2. The method of claim 1 wherein the scoring is based on raw scores associated with the sequence of answers, and continuously estimating the THETA is based at least in part on the scoring and an observed candidate performance pattern pertaining to the sequence of answers.

3. The method of claim 2 wherein the candidate performance pattern is based at least in part on a probability of a candidate correctly answering a next item and a probability of a candidate guessing in answering the next item.

4. The method of claim 3 wherein at least one of the probability of correctly answering the next item and the probability of guessing in answering the next item are based at least in part upon a predetermined difficulty level associated with the next item.

5. The method of claim 1 wherein the probabilistic performance band comprises a range of THETA values determined in accordance with a predetermined statistical confidential interval (CI) associated with respective ones of the THETA in accordance with the continuously estimating.

6. The method of claim 1 wherein the predetermined statistical CI comprises 90% +/−5%.

7. The method of claim 1 wherein cumulatively updating the probabilistic performance band is based at least in part upon scoring a sequence of extended test performance submissions received from the candidate computing device during the extended testing.

8. The method of claim 2 wherein the conclusive fail status is assigned subject to the performance band converging around a trendline associated with the THETA being below the cutoff score during at least a portion of the extended testing.

9. The method of claim 1 wherein the conclusive pass status is assigned subject to the performance band converging around a trendline associated with the THETA being above the cutoff score during at least a portion of the extended testing.

10. The method of claim 1 wherein the conclusive pass status is assigned subject to the THETA being above the cutoff score during at least a portion of the extended testing.

11. A test delivery server computing system communicatively coupled within a distributed network computing system, the test delivery server computing system comprising:
one or more processors; and
a memory storing instructions executable in the one or more processors, the instructions, when executed in the one or more processors, causing the one or more processors to implement operations including:
continuously estimating a candidate performance ability level (“THETA”) based at least in part upon scoring a sequence of test performance answers (“answers”) acquired from a candidate computing device in response to a sequence of items presented to the candidate computing device;
determining, responsive to the continuously estimating, a probabilistic performance band that is associated with the THETA;
generating, based at least in part on the probabilistic performance band and a predetermined cutoff score, a decision to extend the testing in accordance with an extended sequence of items presented to the candidate computing device; and
assigning, in accordance with the extended testing, one of a conclusive fail status and a conclusive pass status based on cumulatively updating the probabilistic performance band in relation to the predetermined cutoff score.

12. The test delivery server computing system of claim 11 wherein the scoring is based on raw scores associated with the sequence of answers, and continuously estimating the THETA is based at least in part on the scoring and an observed candidate performance pattern pertaining to the sequence of answers.

13. The test delivery server computing system of claim 12 wherein the candidate performance pattern is based at least in part on a probability of a candidate correctly answering a next item and a probability of a candidate guessing in answering the next item.

14. The test delivery server computing system of claim 13 wherein at least one of the probability of correctly answering the next item and the probability of guessing in answering the next item are based at least in part upon a predetermined difficulty level associated with the next item.

15. The test delivery server computing system of claim 11 wherein the probabilistic performance band comprises a range of THETA values determined in accordance with a predetermined statistical confidential interval (CI) associated with respective ones of the THETA in accordance with the continuously estimating.

16. The test delivery server computing system of claim 11 wherein the predetermined statistical CI comprises 90% +/−5%.

17. The test delivery server computing system of claim 11 wherein cumulatively updating the probabilistic performance band is based at least in part upon scoring a sequence of extended test performance submissions received from the candidate computing device during the extended testing.

18. The test delivery server computing system of claim 12 wherein the conclusive fail status is assigned subject to the performance band converging around a trendline associated with the THETA being below the cutoff score during at least a portion of the extended testing.

19. The test delivery server computing system of claim 1 wherein the conclusive pass status is assigned subject to at least one of (i) the performance band converging around a trendline associated with the THETA being above the cutoff score during at least a portion of the extended testing, and (ii) subject to the THETA being above the cutoff score during at least a portion of the extended testing.

20. A computer-readable non-transitory memory having instructions stored thereon, the instructions when executed in one or more processors causing the one or more processors to implement operations comprising:
continuously estimating a candidate performance ability level (“THETA”) based at least in part upon scoring a sequence of test performance answers (“answers”) acquired from a candidate computing device in response to a sequence of items presented to the candidate computing device;
determining, responsive to the continuously estimating, a probabilistic performance band that is associated with the THETA;
generating, based at least in part on the probabilistic performance band and a predetermined cutoff score, a decision to extend the testing in accordance with an extended sequence of items presented to the candidate computing device; and
assigning, in accordance with the extended testing, one of a conclusive fail status and a conclusive pass status based on cumulatively updating the probabilistic performance band in relation to the predetermined cutoff score.
